(19) United States
(12) Patent Application Publication
(10) Pub. No.: US 2021/0166321 A1
(43) Pub. Date: Jun. 3, 2021

(54) METHOD FOR THIRD PARTY DATA RETRIEVAL

(71) Applicant: STATE FARM MUTUAL AUTOMOBILE INSURANCE COMPANY, BLOOMINGTON, IL (US)

(72) Inventors: JOEY R. TORREZ, MCKINNEY, TX (US); GREGORY L. MAURER, SACHSE, TX (US)

(73) Assignee: STATE FARM MUTUAL AUTOMOBILE INSURANCE COMPANY, BLOOMINGTON, IL (US)

(21) Appl. No.: 15/056,430

(22) Filed: Feb. 29, 2016

Related U.S. Application Data
(60) Provisional application No. 62/271,739, filed on Dec. 28, 2015.

(51) Int. Cl. G06Q 40/08

(52) U.S. Cl. CPC G06Q 40/08

(57) ABSTRACT

A computer-implemented method for retrieving data regarding insurance policy information from third-party sources with customer permission or affirmative consent. Multiple prompts may be generated and transmitted to a customer's mobile device using radio links and wireless communication. The first prompt may ask the customer if they've purchased a home security system for their house, and a second prompt may ask for information regarding the home security system manufacturer or supplier, and permission to contact them directly if the customer answered “yes” to purchasing the home security system. The security system manufacturer or supplier may be contacted to request proof of purchase or installation if the customer provided contact information and permission. Another prompt may present the customer with information regarding home security systems, or other safety or security products, with features that may generate an insurance premium discount if the customer answered “no” to purchasing a security system.

### CROSS-REFERENCE TO RELATED APPLICATIONS

This application claims the benefit of priority of U.S. Provisional Patent Application Ser. No. 62/271,739, filed Dec. 28, 2015, the contents of which are hereby incorporated by reference, in their entirety and for all purposes, herein.

### FIELD OF THE INVENTION

The present disclosure generally relates to methods, computer servers, and media for retrieving data regarding insurance policy information from third-party sources.

### BACKGROUND

In the insurance industry, discounts on premiums are frequently offered to customers who meet certain qualifications—particularly for homeowner's insurance. Examples of the qualifications may include possessing a security system, the implementation of fire alarms, fire extinguishers, and/or sprinklers throughout the house, the implementation of dead bolt locks, the use of certain impact-resistant roofing materials, recent renovations to the house, and the like.

In order to verify that the qualifications have been properly met, insurance providers may request that the customer's agent contact the customer to contact the person or entity who can provide the verification. The entities who can provide verification may include vendors who sell the products mentioned above, contractors who install them, inspectors who check the installation, and so forth. The verification may include documents, forms, or statements that cover the purchase or installation of the security and safety products.

In addition, insurance providers may require other documents from a customer that are not necessarily related to premium discounts. Exemplary documents may include appraisals of jewelry or other valuables. The process to provide the verification may include generating the documents or forms from the vendors, contractors, product suppliers or manufacturers, inspectors, or appraisers, uploading, emailing, faxing, mailing, or physically delivering the documents to the customer, who then may forward the documents to the agent, who then may forward the documents to an operations center. This process is time consuming and tedious, and includes numerous opportunities for the documents to be misplaced, misrouted, or delayed before they reach their destination.

### BRIEF SUMMARY

Embodiments of the present technology relate to computer-implemented methods, computer servers, and computer-readable media for retrieving data regarding insurance policy information from third-party sources. The embodiments provide for a website environment that asks a customer questions about safety and security features in their house and allows for automatic retrieval of documents, such as invoices and contracts, from relevant third-party sources (e.g., vendors, contractors, and appraisers).

In a first aspect, a computer-implemented method for retrieving data regarding insurance policy information from third-party sources may be provided. The method may include: (1) generating and/or transmitting (such as via one or more radio links and wireless communication/data transmission) a prompt to be presented on a computing device display that asks a customer if they have purchased safety or security products for their house; (2) generating and transmitting another prompt that asks the customer for information regarding a vendor or contractor and permission to contact the vendor or contractor if they answered “yes” to purchasing safety or security products; (3) contacting the vendor or contractor to request proof of purchase or installation if the customer provided contact information and permission; (4) generating and transmitting another prompt that presents the customer with information regarding safety or security products with features that may generate an insurance premium discount if they answered “no” to purchasing safety or security products; (5) generating and transmitting another prompt that asks the customer if they have had renovation work performed on their house; (6) generating and transmitting another prompt that asks the customer for information regarding a contractor and permission to contact the contractor if they answered “yes” to having had renovation work performed on their house; (7) contacting the contractor to request proof of completed work if the customer provided contact information and permission; and/or (8) generating and transmitting another prompt that presents the customer with information that certain types of renovation may generate an insurance premium discount if they answered “no” to having had renovation work performed on their house. The method may include additional, fewer, or alternative actions, including those discussed elsewhere herein.

In another aspect, a computer-readable medium for retrieving data regarding insurance policy information from third-party sources may be provided. The computer-readable medium may include an executable program stored thereon, wherein the program instructs a processing element of a computer server to perform the following steps: (1) generating and transmitting a prompt to be presented on a computing device display that asks a customer if they have purchased safety or security products for their house; (2) generating and transmitting another prompt that asks the customer for information regarding a vendor or contractor and permission to contact the vendor or contractor if they answered “yes” to purchasing safety or security products; (3) contacting the vendor or contractor to request proof of purchase or installation if the customer provided contact information and permission; (4) generating and transmitting another prompt that presents the customer with information regarding safety or security products with features that may generate an insurance premium discount if they answered “no” to purchasing safety or security products; (5) generating and transmitting another prompt that asks the customer if they have had renovation work performed on their house; (6) generating and transmitting another prompt that asks the customer for information regarding a contractor and permission to contact the contractor if they answered “yes” to having had renovation work performed on their house; (7) contacting the contractor to request proof of completed work if the customer provided contact information and permission; and/or (8) generating and transmitting another prompt that presents the customer with information that certain types of renovation may generate an insurance premium discount if they answered “no” to having had renovation work performed on their house. The program stored on the computer-readable medium may instruct the processing element to perform additional, fewer, or alternative actions, including those discussed elsewhere herein.

In yet another aspect, a computer server retrieving data regarding insurance policy information from third-party sources may be provided. The computer server may include a communication element, a memory element, and a processing element. The communication element may receive and transmit communications to and from a plurality of computing devices. The memory element may be electronically coupled to the communication element and may store executable instructions. The processing element may be electronically coupled to the communication element and the memory element. The processing element may be configured to transmit a prompt to be presented on a computing device display that asks a customer if they have purchased safety or security products for their house, transmit another prompt that asks the customer for information regarding a vendor or contractor and permission to contact the vendor or contractor if they answered “yes” to purchasing safety or security products, contact the vendor or contractor to request proof of purchase or installation if the customer provided contact information and permission, transmit another prompt that presents the customer with information regarding safety or security products with features that may generate an insurance premium discount if they answered “no” to purchasing safety or security products, transmit another prompt that asks the customer if they have had renovation work performed on their house, transmit another prompt that asks the customer for information regarding a contractor and permission to contact the contractor if they answered “yes” to having had renovation work performed on their house, contact the contractor to request proof of completed work if the customer provided contact information and permission, and transmit another prompt that presents the customer with information that certain types of renovation may generate an insurance premium discount if they answered “no” to having had renovation work performed on their house. The computer server may include additional, fewer, or alternate components and/or functionality, including that discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of methods and computer servers disclosed therein. It should be understood that each Figure depicts an embodiment of a particular aspect of the disclosed methods and computer servers, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates an exemplary environment in which various embodiments of a computer server, configured to retrieve data regarding insurance policy information from third-party sources, may operate, the exemplary environment including a communication network that allows communication with various computing devices and third parties such as vendors, contractors, and appraisers;

FIG. 2 illustrates various exemplary components of the computer server shown in block schematic form; and

FIGS. 3A and 3B illustrate at least a portion of the steps of an exemplary computer-implemented method for retrieving data regarding insurance policy information from third-party sources.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments described in this patent application and other possible embodiments address a computer-centric challenge or problem with a solution that is necessarily rooted in computer technology and may relate to, inter alia, methods and computer servers for retrieving data regarding insurance policy information from third-party sources. A customer, such as either a potential new customer or an existing customer, may visit a website operated by an insurance provider to apply for an insurance policy or to review the features of an already existing insurance policy. Software executed on the website server may transmit prompts that ask the customer whether their home includes various safety or security products such as a security system, fire alarms, fire extinguishers, sprinklers, dead bolt locks, and the like. Another prompt may ask the customer about architectural or structural features of the house such as the type of material used for the roof of the house, whether renovations have been made recently (within the past year), and so forth. Another prompt may further inquire as to possessions of the customer such as jewelry, artwork, musical instruments, and the like.

If the customer answered yes to any of the inquiries, then the software may prompt the customer to grant permission to the insurance provider to request information from the relevant third party. For example, if the customer responded that their house includes one or more of the safety and security products, then another prompt may ask the customer to provide contact information about the vendor who sold the safety or security product and to grant permission to contact the vendor. Alternatively, if the customer responded that their house includes one or more of the safety and security products, then another prompt may ask the customer to provide contact information about the contractor who installed the product and to grant permission to contact the contractor.

Additionally, if the customer responded that their house has impact-resistant roofing material or that they had renovations done recently, then another prompt may ask the customer to provide contact information about the contractor who installed the material or made the renovations and to grant permission to contact the contractor. Furthermore, if the customer responded that they have valuable possessions, then another prompt may ask if the customer has had the valuables recently appraised. If so, then that additional prompt may ask the customer to provide contact information about the appraiser and to grant permission to contact the appraiser.

If the customer has not had the valuables recently appraised, then the software may request that the customer have the valuables appraised and then provide contact information about the appraiser along with permission to contact the appraiser. Alternatively, the software may provide the names of recommended appraisers and request that the customer select one and grant permission to contact the appraiser once the appraisal is done.

If the customer responded no to all of the inquiries, then the software may inform the customer that they may be eligible for a discount on their insurance premium if they purchase and install certain safety and security products. For example, the software may suggest a security system with specific features, or certain security system models that qualify for the discount, types of door locks, types of fire alarms, fire extinguishers, and sprinklers, and so forth. The software may also inform the customer that architectural or structural improvements to the house, including a new roof with certain impact-resistant materials, may lead to a discount on their insurance premium.

In other aspects, a second software program that is executed on a vendor's web site server, such as for a vendor who sells safety and security products like those discussed above, determines when a customer makes a purchase of any of these products. The second software program may then inform the customer that they might be entitled to a discount on their homeowner's insurance premium by purchasing the product. The second software program may also ask them if they will provide their insurance provider information so that the vendor can send a proof of purchase for the safety and security product directly to the insurance provider.

Specific embodiments of the technology will now be described in connection with the attached drawing figures. The embodiments are intended to describe aspects of the invention in sufficient detail to enable those skilled in the art to practice the invention. Other embodiments may be utilized and changes may be made without departing from the scope of the present invention. The following detailed description is, therefore, not to be taken in a limiting sense. The scope of the present invention is defined only by the appended claims, along with the full scope of equivalents to which such claims are entitled.

### Exemplary Computer Server

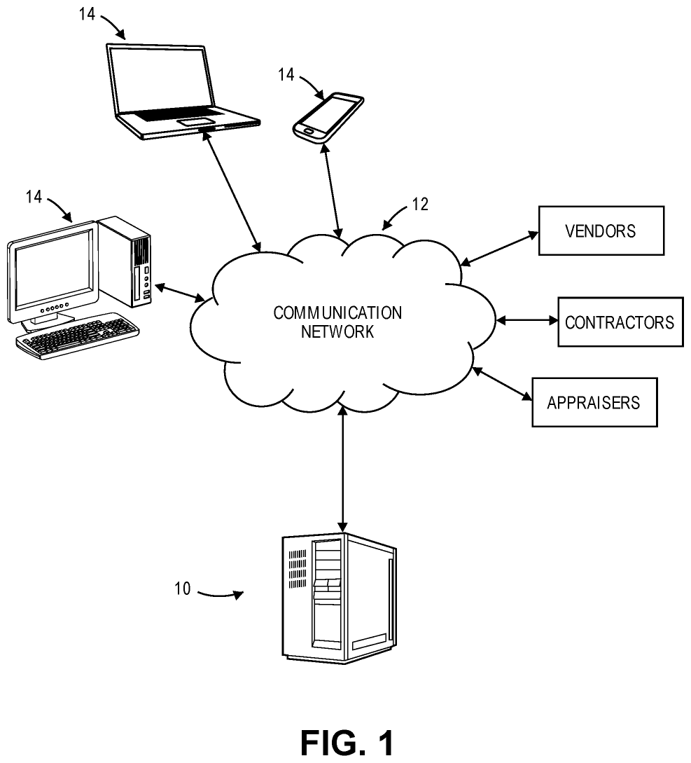

FIG. 1 depicts an exemplary environment in which embodiments of a computer server 10 may be utilized for retrieving data regarding insurance policy information from third-party sources. The environment may include a communication network 12 and a plurality of computing devices 14, such as a desktop computer, a laptop or tablet computer, a smartphone, or similar devices. The communication network 12 may provide wired and/or wireless communication between the computing devices 14 and the computer server 10, which hosts an insurance provider website. The computer server 10 may also communicate with various third parties, such as vendors, contractors, and appraisers. A customer may utilize a computing device 14 to access the website to sign up for a new homeowner's insurance policy, to update information on a current homeowner's insurance policy, or the like.

The communication network 12 generally allows communication between the computing devices 14 and the computer server 10, such as via wireless communication and data transmission over one or more radio links. The communication network 12 may include local area networks, metro area networks, wide area networks, cloud networks, the Internet, cellular networks, plain old telephone service (POTS) networks, and the like, or combinations thereof. The communication network 12 may be wired, wireless, or combinations thereof and may include components such as modems, gateways, switches, routers, hubs, access points, repeaters, towers, and the like. The computing devices 14 may connect to the communication network 12 either through wires, such as electrical cables or fiber optic cables, or wirelessly, such as radio frequency (RF) communication using wireless standards such as cellular 2G, 3G, or 4G, Institute of Electrical and Electronics Engineers (IEEE) 802.11 standards such as WiFi, IEEE 802.16 standards such as WiMAX, Bluetooth™, or combinations thereof.

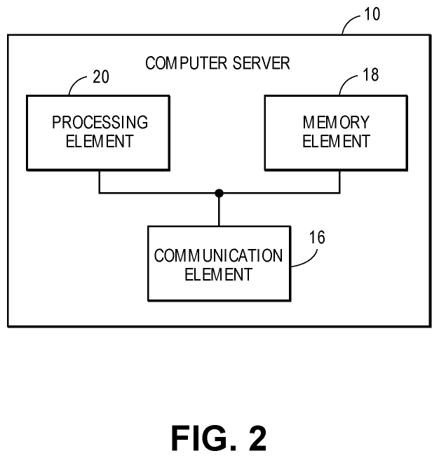

The computer server 10 generally retains electronic data and may respond to requests to retrieve data, as well as to store data. The computer server 10 may be embodied by application servers, database servers, file servers, gaming servers, mail servers, print servers, web servers, or the like, or combinations thereof. Furthermore, the computer server 10 may include a plurality of servers, virtual servers, or combinations thereof. The computer server 10 may be configured to include or execute software such as file storage applications, database applications, email or messaging applications, web server applications, or the like. As indicated in FIG. 2, the computer server 10 may broadly comprise a communication element 16, a memory element 18, and a processing element 20.

The communication element 16 generally allows communication with external systems or devices, again such as via wireless communication and/or data transmission over one or more direct or indirect radio links between devices. The communication element 16 may include signal or data transmitting and receiving circuits, such as antennas, amplifiers, filters, mixers, oscillators, digital signal processors (DSPs), and the like. The communication element 16 may establish communication wirelessly by utilizing RF signals and/or data that comply with communication standards such as cellular 2G, 3G, or 4G, WiFi, WiMAX, Bluetooth™, and the like, or combinations thereof. In addition, the communication element 16 may utilize communication standards such as ANT, ANT+, Bluetooth™ low energy (BLE), the industrial, scientific, and medical (ISM) band at 2.4 gigahertz (GHz), or the like.

Alternatively, or in addition, the communication element 16 may establish communication through connectors or couplers that receive metal conductor wires or cables which are compatible with networking technologies such as ethernet. In certain embodiments, the communication element 16 may also couple with optical fiber cables. The communication element 16 may be in communication with the processing element 20 and the memory element 18, again such as wireless communication and data transmission over one or more radio links.

The memory element 18 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 18 may be embedded in, or packaged in the same package as, the processing element 20. The memory element 18 may include, or may constitute, a “computer-readable medium.” The memory element 18 may store the instructions, code, code segments, software, firmware, programs, applications, apps, services, daemons, or the like that are executed by the processing element 20. The memory element 18 may also store settings, data, documents, sound files, photographs, movies, images, databases, and the like.

The processing element 20 may include electronic hardware components such as processors, microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 20 may generally execute, process, or run instructions, code, code segments, software, firmware, programs, applications, apps, processes, services, daemons, or the like. The processing element 20 may also include hardware components such as finite-state machines, sequential and combinational logic, and other electronic circuits that can perform the functions necessary for the operation of the current invention. The processing element 20 may be in communication with the other electronic components through serial or parallel links that include address busses, data busses, control lines, and the like.

Through hardware, software, firmware, or combinations thereof, the processing element 20 may be configured or programmed to perform the following functions. The processing element 20 may execute code, such as hyper text markup language (HTML), Java, and so forth, to implement a website from an insurance provider. The website may present information about various policies and services offered by the insurance provider. The website may allow a potential new customer to sign up for insurance coverage. The web site may also allow an existing customer to change their policy or provide updated information after a move, a change in the family, renovation to the house, and the like. The customer may execute a browser application on their computing device 14 that allows them to access the website on the computer server 10 in a generally known fashion.

When the customer is seeking or updating a homeowner's insurance policy, the processing element 20 may execute a software application or computer-implemented method as part of the website code or in addition to the website code. In this situation, the processing element 20 may generate and transmit instructions, through the communication element 16 and the communication network 12 (over one or more radio links), to the computing device 14 that present a prompt on a display of the computing device 14. The prompt may include questions regarding the home, or provide information to the customer, that appear in a pop-up window or as part of a list or sequence of questions on a regular page of the web site. The prompt may ask the customer if they have recently purchased and installed any safety and security products. The safety and security products may include a security system, fire alarms, fire extinguishers, sprinklers, dead bolt locks, and the like. The processing element 20 may also generate and transmit another prompt, over the one or more radio links, that asks the customer about architectural or structural features of the house such as the type of material used for the roof of the house, whether renovations, such as remodeling or adding on to the house, have been made recently (within the past year), and so forth. The processing element 20 may further transmit another prompt that inquires as to possessions of the customer such as jewelry, artwork, musical instruments, and the like.

If the customer answers yes to the purchase and installation of any safety and security products, specifies that impact-resistant material has been used on the roof or that renovations have recently been done, or specifies that they certain types of valuables, then the processing element 20 may generate and transmit another prompt, over one or more radio links, for the customer to grant permission to the insurance provider to request information from the relevant third party. For example, if the customer responded that their house includes one or more of the safety and security products, then the processing element 20 may generate and transmit, over one or more radio links, another prompt to ask the customer to provide contact information about the vendor who sold the safety or security product, and to grant permission to contact the vendor.

After receiving permission, the processing element 20 may then contact the vendor, through the communication element 16 and the communication network 12, such as via one or more radio links, and request documents that provide a proof of purchase, such as an invoice or a sales receipt. Alternatively, if the customer responded that their house includes one or more of the safety and security products, then the processing element 20 may generate and transmit, via one or more radio links, another prompt to ask the customer to provide contact information about the contractor who installed the product, and to grant permission to contact the contractor. After receiving permission, the processing element 20 may then contact the contractor and request documents (over one or more radio links), such as an invoice or receipt for the installation, or a statement from the contractor attesting that he installed the safety or security product.

If the customer responds that their house has impact-resistant roofing material or that they had renovations done recently, then the processing element 20 may generate and transmit, via one or more radio links, another prompt to ask the customer to provide contact information about the contractor who installed the material or made the renovations, and to grant permission to contact the contractor. After receiving the information and permission, the processing element 20 may then, over one or more radio links, contact the contractor and request documents, such as a contract, invoice, or receipt for the work, or a statement from the contractor attesting that he performed the installation or renovation.

If the customer responds that they have valuable possessions, then the processing element 20 may generate and transmit, over one or more radio links, another prompt to ask if the customer has had the valuables recently appraised. If so, then the processing element 20 may generate and transmit, over one or more radio links, another prompt to ask the customer to provide contact information about the appraiser and to grant permission to contact the appraiser. After receiving the information and permission, the processing element 20 may then contact the appraiser and request a copy of the appraisal (such as one or more radio links). If the customer has not had the valuables recently appraised, then the processing element 20 may generate and transmit, over one or more radio links, another prompt to request that the customer have the valuables appraised, and then provide contact information about the appraiser along with permission to contact the appraiser.

After receiving the information and permission, the processing element 20 may then contact the appraiser and request a copy of the appraisal, such as via wireless communication and/or one or more radio links. Alternatively, the processing element 20 may provide the names of recommended appraisers, and generate and transmit, over one or more radio links, another prompt to request that the customer select one and grant permission to contact the appraiser once the appraisal is done. After a period of time has elapsed (such as a month), the processing element 20 may then contact the appraiser that was selected and request a copy of the appraisal, such as via wireless communication and over one or more radio links.

If the customer responded no to all of the inquiries, then the processing element 20 may generate and transmit, via wireless communication and using one or more radio links, another prompt to inform the customer that they may be eligible for a discount on their insurance premium if they purchase and install certain safety and security products. For example, the processing element 20 may generate and transmit another prompt to suggest a security system with specific features, or certain security system models that qualify for the discount, types of door locks, types of fire alarms, fire extinguishers, and sprinklers, and so forth. In various embodiments, the processing element 20 may generate and transmit another prompt to further suggest approved vendors or manufacturers of safety and security products. The processing element 20 may also generate and transmit another prompt to inform the customer that architectural or structural improvements to the house, including a new roof with certain impact-resistant materials, may lead to a discount on their insurance premium.

A second embodiment of the computer server 210 may include the same structure as the computer server 10 discussed above, with at least a processing element 220 similar to the processing element 20. However, the computer server 210 may implement a website for a vendor who sells safety and security products. The vendor website may display safety and security products and may allow the customer to buy the products in a generally known fashion. The processing element 220 may be configured or programmed to determine when the customer makes a purchase of any of these products. The processing element 220 may then generate and transmit, via wireless communication using one or more radio links between various devices, a prompt to inform the customer that they might be entitled to a discount on their homeowner's insurance premium by purchasing the product. The processing element 220 may also generate and transmit another prompt to ask them if they will provide their insurance provider information so that the vendor can send a proof of purchase for the safety and security product directly to the insurance provider.

### Exemplary Computer-Implemented Method

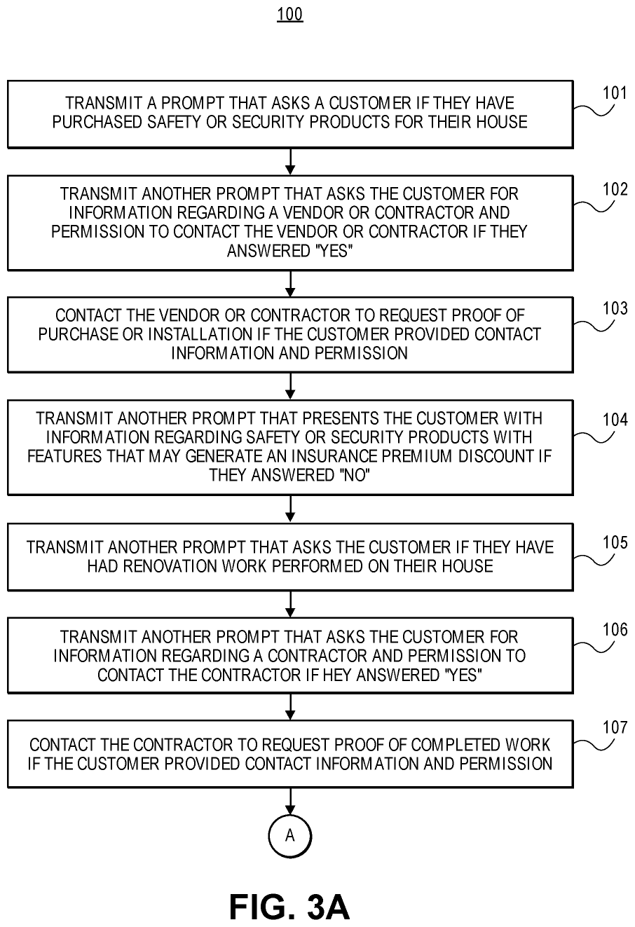

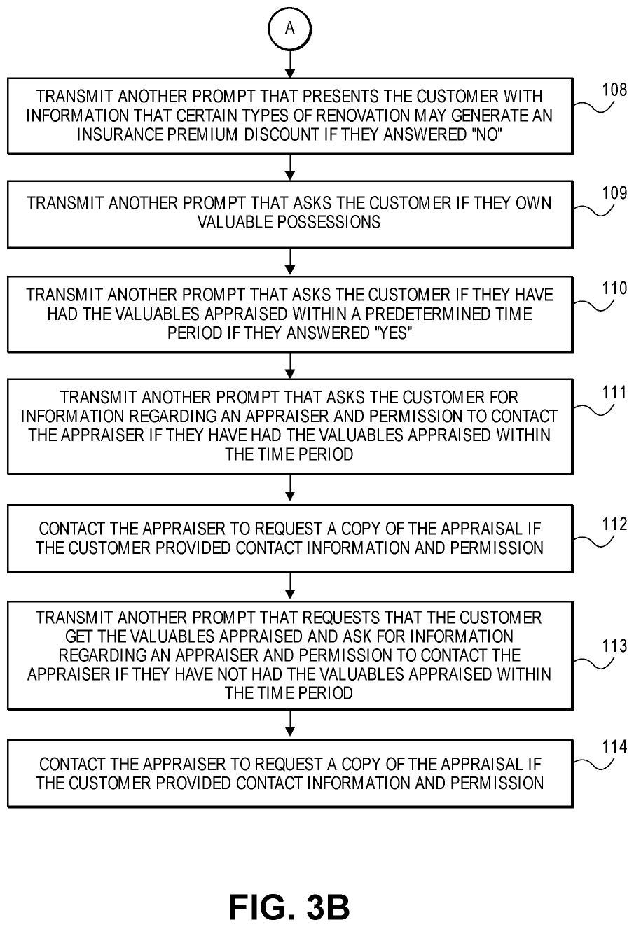

FIG. 3 depicts a listing of steps of an exemplary computer-implemented method 100 for retrieving data regarding insurance policy information from third-party sources. The steps may be performed in the order shown in FIGS. 3A and 3B, or they may be performed in a different order. Furthermore, some steps may be performed concurrently as opposed to sequentially. In addition, some steps may be optional. The steps of the computer-implemented method 100 may be performed by the computer server 10.

Referring to step 101, a prompt may be generated and/or transmitted, such as via wireless communication and using one or more radio links between devices, that asks a customer if they have purchased safety or security products for their house. The customer may log on to or visit a website provided by an insurance provider which allows a potential new customer to sign up for insurance coverage or an existing customer to change their policy or provide updated information after a move, a change in the family, renovation to the house, and the like. The customer may execute a browser application on their computing device 14 that allows them to access the website on the computer server 10 in a generally known fashion. The computer server 10 may generate and/or transmit the prompt to be presented on a display of the computing device 14. The prompt may include questions regarding the home, or provide information to the customer, that appear in a pop-up window or as part of a list or sequence of questions on a regular page of the website. The safety and security products may include a security system, fire alarms, fire extinguishers, sprinklers, dead bolt locks, and the like.

Referring to step 102, another prompt may be generated and/or transmitted, via wireless communication and one or more radio links, that asks the customer for information regarding a vendor or contractor and permission to contact the vendor or contractor if they answered “yes” to purchasing safety or security products. The vendor may have sold the safety or security product to the customer, while the contractor may have installed the safety or security product in the customer's house. The information may include a regular mailing address, a phone number, an email address, a web site, or the like.

Referring to step 103, the vendor or contractor may be contacted, again via wireless communication and over one or more radio links, to request proof of purchase or installation if the customer provided contact information and permission. The contact may be initiated by the computer server 10, and may involve the computer server 10 sending email, a text message, voicemail, or the like to the vendor or contractor. The proof of purchase may include documents such as an invoice or a sales receipt or the like. The proof of installation may include an invoice or receipt for the installation, or a statement from the contractor attesting that he installed the safety or security product.

Referring to step 104, another prompt may be generated and/or transmitted, via wireless communication and one or more radio links, that presents the customer with information regarding safety or security products with features that may generate an insurance premium discount if they answered “no” that they do not have safety or security products in their house. For example, the customer may be presented with information about security systems with specific features, or certain security system models that qualify for the discount, types of door locks, types of fire alarms, fire extinguishers, and sprinklers, and so forth. In various embodiments, the customer may further be presented with approved vendors or manufacturers of safety and security products.

Referring to step 105, another prompt may be generated and/or transmitted, via wireless communication and one or more radio links, that asks the customer if they have had renovation work performed on their house. The renovation work may include remodeling one or more rooms of the house, adding on to the house, having a new roof installed, and the like. In some embodiments, the customer may be specifically asked if the renovation occurred within the last year. In various embodiments, the customer may further be asked what type of material is used for the roof.

Referring to step 106, another prompt may be generated and/or transmitted, via wireless communication and one or more radio links, that asks the customer for information regarding a contractor and permission to contact the contractor if they answered “yes” to having had renovation work performed on their house. The customer may also be asked for contractor information and permission to contact the contractor if the customer had impact-resistant material used on their roof.

Referring to step 107, the contractor may be contacted, such as via wireless communication and one or more radio links, to request proof of completed work if the customer provided contact information and permission. The proof may include documents such as contracts, invoices, or a statement from the contractor attesting that he performed the renovation work.

Referring to step 108, another prompt may be generated and/or transmitted, via wireless communication and one or more radio links, that presents the customer with information that certain types of renovation may generate an insurance premium discount if they answered “no” that they had not renovation work performed on their house. Furthermore, the customer may be presented with information regarding impact-resistant roofing material.

Referring to step 109, another prompt may be generated and/or transmitted, via wireless communication and one or more radio links, that asks the customer if they own valuable possessions. The valuables may include jewelry, artwork, musical instruments, and the like.

Referring to step 110, another prompt may be generated and/or transmitted, via wireless communication and one or more radio links, that asks the customer if they have had the valuables appraised within a predetermined time period if they answered “yes” that they own valuables. The predetermined time period may be limited to within the last year.

Referring to step 111, another prompt may be generated and/or transmitted, via wireless communication and one or more radio links, that asks the customer for information regarding an appraiser and permission to contact the appraiser if they have had the valuables appraised within the time period.

Referring to step 112, the appraiser may be contacted, via wireless communication and one or more radio links, to request a copy of the appraisal if the customer provided contact information and permission.

Referring to step 113, another prompt may be generated and/or transmitted, via wireless communication and one or more radio links, that requests the customer get the valuables appraised and is asked for information regarding an appraiser and permission to contact the appraiser if they have not had the valuables appraised within the time period. Alternatively, the customer may be provided with the names of recommended appraisers. The customer may also be requested to select one, and grant permission to contact the appraiser once the appraisal is done.

Referring to step 114, the appraiser may be contacted, via wireless communication and one or more radio links, to request a copy of the appraisal if the customer provided contact information and permission. In various embodiments, the appraiser may be contacted after an amount of time has passed to allow the appraisal to be completed.

### Exemplary Computer-Implemented Method for Retrieving Data Regarding Insurance Policy Information From 3^{rd} Party Sources

In a first aspect, a computer-implemented method for retrieving data regarding insurance policy information from third-party sources may be provided. The method may include: (1) transmitting a prompt to be presented on a computing device display that asks a customer if they have purchased safety or security products for their house; (2) transmitting another prompt that asks the customer for information regarding a vendor or contractor and permission to contact the vendor or contractor if they answered “yes” to purchasing safety or security products; (3) contacting the vendor or contractor to request proof of purchase or installation if the customer provided contact information and permission; (4) transmitting another prompt that presents the customer with information regarding safety or security products with features that may generate an insurance premium discount if they answered “no” to purchasing safety or security products; (5) transmitting another prompt that asks the customer if they have had renovation work performed on their house; (6) transmitting another prompt that asks the customer for information regarding a contractor and permission to contact the contractor if they answered “yes” to having had renovation work performed on their house; (7) contacting the contractor to request proof of completed work if the customer provided contact information and permission; and/or (8) transmitting another prompt that presents the customer with information that certain types of renovation may generate an insurance premium discount if they answered “no” to having had renovation work performed on their house. The method may include additional, fewer, or alternative actions, including those discussed elsewhere herein.

For instance, the method may include: transmitting another prompt that asks the customer if they own valuable possessions; transmitting another prompt that asks the customer if they have had the valuables appraised within a predetermined first time period if they answered “yes” to owning valuables; transmitting another prompt that asks the customer for information regarding an appraiser and permission to contact the appraiser if they have had the valuables appraised within the first time period; and/or contacting the appraiser to request a copy of the appraisal if the customer provided contact information and permission. The method may also include transmitting another prompt that requests that the customer get the valuables appraised and asks for information regarding an appraiser, and permission to contact the appraiser if they have not had the valuables appraised within the first time period; and/or contacting the appraiser to request a copy of the appraisal if the customer provided contact information and permission. The method may further include transmitting another prompt that provides the customer with a list of recommended appraisers, and requests that the customer select one of the appraisers and grant permission to contact the appraiser after a second time period; and/or contacting the appraiser to request a copy of the appraisal if the customer provided contact information and permission. The method may additionally include transmitting another prompt that asks the customer what type of material is used for the roof of the house; transmitting another prompt that asks the customer for information regarding a contractor and permission to contact the contractor if they answered that the roof material is impact-resistant; and/or contacting the contractor to request proof of completed work if the customer provided contact information and permission. In addition, the method may include transmitting another prompt that presents the customer with a list of approved vendors or manufacturers of safety and security products if they answered “no” to purchasing safety or security products.

### Exemplary Computer-Readable Medium for Retrieving Data Regarding Insurance Policy Information From 3^{rd} Party Sources

In another aspect, a computer-readable medium for retrieving data regarding insurance policy information from third-party sources may be provided. The computer-readable medium may include an executable program stored thereon, wherein the program instructs a processing element of a computer server to perform the following steps: (1) transmitting a prompt to be presented on a computing device display that asks a customer if they have purchased safety or security products for their house; (2) transmitting another prompt that asks the customer for information regarding a vendor or contractor and permission to contact the vendor or contractor if they answered “yes” to purchasing safety or security products; (3) contacting the vendor or contractor to request proof of purchase or installation if the customer provided contact information and permission; (4) transmitting another prompt that presents the customer with information regarding safety or security products with features that may generate an insurance premium discount if they answered “no” to purchasing safety or security products; (5) transmitting another prompt that asks the customer if they have had renovation work performed on their house; (6) transmitting another prompt that asks the customer for information regarding a contractor and permission to contact the contractor if they answered “yes” to having had renovation work performed on their house; (7) contacting the contractor to request proof of completed work if the customer provided contact information and permission; and/or (8) transmitting another prompt that presents the customer with information that certain types of renovation may generate an insurance premium discount if they answered “no” to having had renovation work performed on their house. The program stored on the computer-readable medium may instruct the processing element to perform additional, fewer, or alternative actions, including those discussed elsewhere herein.

For instance, the program may instruct the processing element to: transmit another prompt that asks the customer if they own valuable possessions; transmit another prompt that asks the customer if they have had the valuables appraised within a predetermined first time period if they answered “yes” to owning valuables; transmit another prompt that asks the customer for information regarding an appraiser and permission to contact the appraiser if they have had the valuables appraised within the first time period; and/or contact the appraiser to request a copy of the appraisal if the customer provided contact information and permission. The program may also instruct the processing element to transmit another prompt that requests that the customer get the valuables appraised and asks for information regarding an appraiser and permission to contact the appraiser if they have not had the valuables appraised within the first time period; and/or contact the appraiser to request a copy of the appraisal if the customer provided contact information and permission. The program may further instruct the processing element to transmit another prompt that provides the customer with a list of recommended appraisers and requests that the customer select one of the appraisers and grant permission to contact the appraiser after a second time period; and/or contact the appraiser to request a copy of the appraisal if the customer provided contact information and permission.

The program may additionally instruct the processing element to transmit another prompt that asks the customer what type of material is used for the roof of the house; transmit another prompt that asks the customer for information regarding a contractor and permission to contact the contractor if they answered that the roof material is impact-resistant; and/or contact the contractor to request proof of completed work if the customer provided contact information and permission. In addition, the program may instruct the processing element to transmit another prompt that presents the customer with a list of approved vendors or manufacturers of safety and security products if they answered “no” to purchasing safety or security products.

### Exemplary Computer Server Retrieving Data Regarding Insurance Policy Information From 3^{rd} Party Sources

In yet another aspect, a computer server retrieving data regarding insurance policy information from third-party sources may be provided. The computer server may include a communication element, a memory element, and a processing element. The communication element may receive and transmit communications to and from a plurality of computing devices. The memory element may be electronically coupled to the communication element and may store executable instructions. The processing element may be electronically coupled to the communication element and the memory element. The processing element may be configured to (1) generate and transmit a prompt to be presented on a computing device display that asks a customer if they have purchased safety or security products for their house; (2) generate and transmit another prompt that asks the customer for information regarding a vendor or contractor and permission to contact the vendor or contractor if they answered “yes” to purchasing safety or security products; (3) contact the vendor or contractor to request proof of purchase or installation if the customer provided contact information and permission; (4) generate and transmit another prompt that presents the customer with information regarding safety or security products with features that may generate an insurance premium discount if they answered “no” to purchasing safety or security products; (5) generate and transmit another prompt that asks the customer if they have had renovation work performed on their house; (6) generate and transmit another prompt that asks the customer for information regarding a contractor and permission to contact the contractor if they answered “yes” to having had renovation work performed on their house; (7) contact the contractor to request proof of completed work if the customer provided contact information and permission; and/or (8) transmit another prompt that presents the customer with information that certain types of renovation may generate an insurance premium discount if they answered “no” to having had renovation work performed on their house. The computer server may include additional, fewer, or alternate components and/or functionality, including that discussed elsewhere herein.

For instance, the processing element may be further configured to: generate and transmit another prompt that asks the customer if they own valuable possessions; generate and transmit another prompt that asks the customer if they have had the valuables appraised within a predetermined first time period if they answered “yes” to owning valuables; generate and transmit another prompt that asks the customer for information regarding an appraiser and permission to contact the appraiser if they have had the valuables appraised within the first time period; and/or contact the appraiser to request a copy of the appraisal if the customer provided contact information and permission. The processing element may also be configured to generate and transmit another prompt that requests that the customer get the valuables appraised and asks for information regarding an appraiser and permission to contact the appraiser if they have not had the valuables appraised within the first time period; and/or contact the appraiser to request a copy of the appraisal if the customer provided contact information and permission.

The processing element may additionally be configured to generate and transmit another prompt that requests that the customer get the valuables appraised and asks for information regarding an appraiser and permission to contact the appraiser if they have not had the valuables appraised within the first time period; and/or contact the appraiser to request a copy of the appraisal if the customer provided contact information and permission. Furthermore, the processing element may be configured to generate and transmit another prompt that asks the customer what type of material is used for the roof of the house; generate and transmit another prompt that asks the customer for information regarding a contractor and permission to contact the contractor if they answered that the roof material is impact-resistant; and/or contact the contractor to request proof of completed work if the customer provided contact information and permission. In addition, the processing element may be configured to generate and transmit another prompt that presents the customer with a list of approved vendors or manufacturers of safety and security products if they answered “no” to purchasing safety or security products.

### Additional Exemplary Computer-Implemented Methods

In one aspect, a computer-implemented method of verifying entitlement to a home security system discount may be provided. The method may include (1) receiving, via one or more processors and/or transceivers, via wireless communication or data transmission over one or more radio links, a notification that a customer has purchased a home security system; (2) generating and transmitting, via the one or more processors and/or transceivers, an electronic message that asks the customer for permission to directly contact the supplier or manufacturer of the home security system; (3) receiving, via the one or more processors and/or transceivers, home security system documentation data, and purchase and installation confirmation data directly from a transceiver or processor associated with the supplier or manufacturer of the home security system via wireless communication and/or data transmission, over one or more radio links; (4) verifying, via the one or more processors, that the customer installed a new home security system based upon computer analysis of the purchase and installation confirmation data received from the supplier or manufacturer of the home security system via wireless communication; (5) determining, via the one or more processors, one or more features of the home security system based upon computer analysis of the home security system documentation data received from the supplier or manufacturer of the home security system via wireless communication; (6) determining, via the one or more processors, that the customer is entitled to discount on homeowners insurance due to (1) verification of the installation of a new or upgraded home security system; and/or (2) home security system feature identification; (7) applying, via the one or more processors, the discount to the customer's homeowners insurance policy or otherwise update, via the one or more processors, the customer's homeowners insurance policy based upon the discount for the new home security system; (8) generating, via the one or more processors, an electronic message indicating the updated homeowner's insurance product or discount to be applied based upon the purchase and installation of the home security system; and/or (9) transmitting, via the one or more processors and/or associated transceivers, the electronic message to the customer's mobile device to facilitate providing discounts to risk averse customers that have purchased a new home security system or are about to purchase a new home security system.

In another aspect, a computer-implemented method of verifying entitlement to a home security system discount may be provided. The method may include (1) receiving, via one or more processors and/or transceivers, via wireless communication or data transmission over one or more radio links, home sensor data associated with a home security system from customer smart home controller or mobile device; (2) analyzing, via the one or more processors, the home sensor data to determine that the customer has purchased or installed a new security system in the home, such as by inputting, via the one or more processors, the home sensor data into a machine learning, object recognition, or optical character recognition program that determines that the customer has purchased a new home security system; (3) generating and transmitting, via the one or more processors and/or transceivers, an electronic message that asks the customer for permission to directly contact the supplier or manufacturer of the home security system; (4) receiving, via the one or more processors and/or transceivers, home security system documentation data, and purchase and installation confirmation data directly from a transceiver or processor associated with the supplier or manufacturer of the home security system via wireless communication and/or data transmission, over one or more radio links; (5) verifying, via the one or more processors, that the customer installed a new home security system based upon computer analysis of the purchase and installation confirmation data received from the supplier or manufacturer of the home security system via wireless communication; (6) determining, via the one or more processors, one or more features of the home security system based upon computer analysis of the home security system documentation data received from the supplier or manufacturer of the home security system via wireless communication; (7) determining, via the one or more processors, that the customer is entitled to discount on homeowners insurance due to (i) verification of the installation of a new or upgraded home security system; and/or (ii) home security system feature identification; (8) applying, via the one or more processors, the discount to the customer's homeowners insurance policy or otherwise update, via the one or more processors, the customer's homeowners insurance policy based upon the discount for the new home security system; (9) generating, via the one or more processors, an electronic message indicating the updated homeowner's insurance product or discount to be applied based upon the purchase and installation of the home security system; and/or (10) transmitting, via the one or more processors and/or associated transceivers, the electronic message to the customer's mobile device to facilitate providing discounts to risk averse customers that have purchased a new home security system or are about to purchase a new home security system.

The foregoing methods may include additional, less, or alternate actions, including those discussed elsewhere herein. The foregoing methods may be implemented via one or more local or remote processors and transceivers, and/or via computer-executable instructions stored on non-transitory computer-readable media or medium.

### Additional Exemplary Computer Systems

In one aspect, a computer system configured to verify entitlement to a home security system discount may be provided. The computer system may include one or more processors and/or transceivers configured to: (1) receive via wireless communication or data transmission over one or more radio links, a notification that a customer has purchased a home security system; (2) generate and transmit an electronic message that asks the customer for permission to directly contact the supplier or manufacturer of the home security system; (3) receive (i) home security system documentation data, and (ii) purchase and installation confirmation data directly from a transceiver or processor associated with the supplier or manufacturer of the home security system via wireless communication and/or data transmission, over one or more radio links; (4) verify that the customer installed a new home security system based upon computer analysis of the purchase and installation confirmation data received from the supplier or manufacturer of the home security system via wireless communication; (5) determine one or more features of the home security system based upon computer analysis of the home security system documentation data received from the supplier or manufacturer of the home security system via wireless communication; (6) determine that the customer is entitled to discount on homeowners insurance due to (a) verification of the installation of a new or upgraded home security system; and/or (b) home security system feature identification; (7) apply the discount to the customer's homeowners insurance policy or otherwise update, via the one or more processors, the customer's homeowners insurance policy based upon the discount for the new home security system; (8) generate an electronic message indicating the updated homeowner's insurance product or discount to be applied based upon the purchase and installation of the home security system; and/or (9) transmit the electronic message to the customer's mobile device to facilitate providing discounts to risk averse customers that have purchased a new home security system or are about to purchase a new home security system.

In another aspect, a computer system for verifying entitlement to a home security system discount may be provided. The computer system may include one or more processors and/or transceivers configured to: (1) receive via wireless communication or data transmission over one or more radio links, home sensor data associated with a home security system from customer smart home controller or mobile device; (2) analyze the home sensor data to determine that the customer has purchased or installed a new security system in the home, such as by inputting, via the one or more processors, the home sensor data into a machine learning, object recognition, or optical character recognition, or pattern recognition program that determines that the customer has purchased a new home security system; (3) generate and transmit an electronic message that asks the customer for permission to directly contact the supplier or manufacturer of the home security system; (4) receive (i) home security system documentation data, and/or (ii) purchase and installation confirmation data directly from a transceiver or processor associated with the supplier or manufacturer of the home security system via wireless communication and/or data transmission, over one or more radio links; (5) verify that the customer installed a new home security system based upon computer analysis of the purchase and installation confirmation data received from the supplier or manufacturer of the home security system via wireless communication; (6) determine one or more features of the home security system based upon computer analysis of the home security system documentation data received from the supplier or manufacturer of the home security system via wireless communication; (7) determine that the customer is entitled to discount on homeowners insurance due to (a) verification of the installation of a new or upgraded home security system; and/or (b) home security system feature identification; (8) apply the discount to the customer's homeowners insurance policy or otherwise update, via the one or more processors, the customer's homeowners insurance policy based upon the discount for the new home security system; (9) generate an electronic message indicating the updated homeowner's insurance product or discount to be applied based upon the purchase and installation of the home security system; and/or (10) transmit the electronic message to the customer's mobile device to facilitate providing discounts to risk averse customers that have purchased a new home security system or are about to purchase a new home security system. The foregoing computer systems may include additional, less, or alternate functionality, including that discussed elsewhere herein.

### Additional Considerations

With the foregoing, an insurance customer may opt-in to a rewards, insurance discount, or other type of program. After the insurance customer provides their affirmative consent, an insurance provider telematics application and/or remote server may collect smart home, mobile device, vehicle, telematics and/or other data (including image or audio data) associated with insured assets, including before, during, and/or after an insurance-related event. In return, risk-averse home and/or vehicle owners may receive discounts or insurance cost savings related to auto, home, life, renters, pet, and other types of insurance from the insurance provider.

In one aspect, sensor or other data may be collected or received by an insured's smart home, mobile device or smart vehicle, a 3^{rd} party service provider, and/or an insurance provider remote server, such as via direct or indirect wireless communication or data transmission from an application running on the insured's smart home controller, mobile device or vehicle, or 3^{rd} party remote server, after the insured or customer affirmatively consents or otherwise opts-in to an insurance discount, reward, or other program. The insurance provider may then analyze the data received with the customer's permission to provide benefits to the customer. As a result, risk-averse customers may receive insurance discounts or other insurance cost savings based upon functionality and/or technology discussed herein that may mitigate or prevent risk to (i) insured assets, such as vehicles or homes, and/or (ii) insureds and family members caused by insurance-related events.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A computer-implemented method for retrieving data regarding insurance policy information from third-party sources, the computer-implemented method comprising:
transmitting, by a server to a computing device, a prompt to be presented on a display of the computing device that asks a customer if the customer has purchased safety or security products for the customer's house;
in response to receiving, by the server from the computing device, information indicating that the customer answered “yes” to purchasing safety or security products, transmitting, by the server to the computing device, another prompt to be presented on the display of the computing device that asks the customer for contact information regarding a vendor or contractor and permission to contact the vendor or contractor;
in response to receiving, by the server from the computing device, information indicating that the customer provided the contact information and permission regarding the vendor or contractor,
transmitting, by the server to a device associated with the vendor or contractor, a request for proof of purchase or installation of the safety or security products;
receiving, by the server from the device associated with the vendor or contractor, documentation data of the safety or security products;
determining, by the server, one or more features of the safety or security products based upon computer analysis of the documentation data;
collecting, by the server, home sensor data from at least one of a sensor and a smart home controller;
analyzing, by the server, the home sensor data using at least one of an object recognition program and a pattern recognition program to identify at least one of the safety or security products;
verifying, by the server, an installation of the at least one of the safety or security products based on the analysis of the home sensor data; and
in response to receiving, by the server from the computing device, information indicating that the customer answered “no” to purchasing safety or security products, transmitting, by the server to the computing device, another prompt to be presented on the display of the computing device that presents the customer with information regarding safety or security products with features that may generate an insurance premium discount.

2. The computer-implemented method of claim 1, further comprising:
transmitting, by the server to the computing device, another prompt to be presented on the display of the computing device that asks the customer if the customers owns valuable possessions;
in response to receiving, by the server from the computing device, information indicating that the customer answered “yes” to owning valuable possessions, transmitting, by the server to the computing device, another prompt to be presented on the display of the computing device that asks the customer if the customer has had the valuable possessions appraised within a predetermined first time period;
in response to receiving, by the server from the computing device, information indicating that the customer has had the valuable possessions appraised, transmitting, by the server to the computing device, another prompt to be presented on the display of the computing device that asks the customer for contact information regarding an appraiser and permission to contact the appraiser; and
in response to receiving, by the server from the computing device, information indicating that the customer provided the contact information and permission regarding the appraiser, transmitting, by the server to a device associated with the appraiser, a request for a copy of the appraisal.

3. The computer-implemented method of claim 2, further comprising:
in response to receiving, by the server from the computing device, information indicating that the customer has not had the valuable possessions appraised, transmitting, by the server to the computing device, another prompt to be presented on the display of the computing device that requests that the customer get the valuable possessions appraised by an appraiser and asks for contact information regarding the appraiser and permission to contact the appraiser; and
in response to receiving, by the server from the computing device, information indicating that the customer provided the contact information and permission regarding the appraiser, transmitting, by the server to a device associated with the appraiser, a request for a copy of the appraisal.

4. The computer-implemented method of claim 2, further comprising:
transmitting, by the server to the computing device, another prompt to be presented in the display of the computing device that provides the customer with a list of recommended appraisers and requests that the customer select one of the appraisers and grant permission to contact the selected one of the appraisers after a second time period; and
in response to receiving, by the server from the computing device, information indicating that the customer provided the permission regarding the selected one of the appraisers, transmitting, by the server to a device associated with the selected one of the appraisers, a request for a copy of the appraisal.

5. The computer-implemented method of claim 1, further comprising:
transmitting, by the server to the computing device, another prompt to be presented in the display of the computing device that asks the customer what type of material is used for the roof of the customer's house;
in response to receiving, by the server from the computing device, information indicating that the customer answered that the roof material is impact-resistant, transmitting, by the server to the computing device, another prompt to be presented in the display of the computing device that asks the customer for contact information regarding a contractor and permission to contact the contractor; and
in response to receiving, by the server from the computing device, information indicating that the customer provided the contact information and permission regarding the contractor, transmitting, by the server to a device associated with the contractor, a request for proof of the completed work on the roof.

6. The computer-implemented method of claim 1, further comprising:
in response to receiving, by the server from the computing device, information indicating that the customer answered “no” to purchasing safety or security products, transmitting, by the server to the computing device, another prompt to be presented in the display of the computing device that presents the customer with a list of approved vendors or manufacturers of safety and security products.

7. A non-transitory computer-readable medium with an executable program stored thereon for retrieving data regarding insurance policy information from third-party sources, wherein the program instructs a processing element of a computer server to perform the following steps:
transmitting, to a computing device, a prompt to be presented on a display of the computing device that asks a customer if the customer has purchased safety or security products for the customer's house;
in response to receiving, from the computing device, information indicating that the customer answered “yes” to purchasing safety or security products, transmitting, to the computing device, another prompt to be presented on the display of the computing device that asks the customer for contact information regarding a vendor or contractor and permission to contact the vendor or contractor;
in response to receiving, from the computing device, information indicating that the customer provided the contact information and permission regarding the vendor or contractor,
transmitting, to a device associated with the vendor or contractor, a request for proof of purchase or installation of the safety or security products;
receiving, from the device associated with the vendor or contractor, documentation data of the safety or security products;
determining one or more features of the safety or security products based upon computer analysis of the documentation data;
collecting home sensor data from at least one of a sensor and a smart home controller;
analyzing the home sensor data using at least one of an object recognition program and a pattern recognition program to identify at least one of the safety or security products;
verifying an installation of the at least one of the safety or security products based on the analysis of the home sensor data; and
in response to receiving, from the computing device, information indicating that the customer answered “no” to purchasing safety or security products, transmitting, to the computing device, another prompt to be presented in the display of the computing device that presents the customer with information regarding safety or security products with features that may generate an insurance premium discount.

8. The non-transitory computer-readable medium of claim 7, wherein the program further instructs the processing element to:
transmit, to the computing device, another prompt to be presented in the display of the computing device that asks the customer if the customers owns valuable possessions;
in response to receiving, from the computing device, information indicating that the customer answered “yes” to owning valuable possessions, transmit, to the computing device, another prompt to be presented in the display of the computing device that asks the customer if the customer has had the valuable possessions appraised within a predetermined first time period;
in response to receiving, from the computing device, information indicating that the customer has had the valuable possessions appraised, transmit, to the computing device, another prompt to be presented in the display of the computing device that asks the customer for contact information regarding an appraiser and permission to contact the appraiser; and
in response to receiving, from the computing device, information indicating that the customer provided the contact information and permission regarding the appraiser, transmit, to a device associated with the appraiser, a request for a copy of the appraisal.

9. The non-transitory computer-readable medium of claim 8, wherein the program further instructs the processing element to:
in response to receiving, from the computing device, information indicating that the customer has not had the valuable possessions appraised, transmit, to the computing device, another prompt to be presented in the display of the computing device that requests that the customer get the valuable possessions appraised by an appraiser and asks for contact information regarding the appraiser and permission to contact the appraiser; and
in response to receiving, from the computing device, information indicating that the customer provided the contact information and permission regarding the appraiser, transmit, to a device associated with the appraiser, a request for a copy of the appraisal.

10. The non-transitory computer-readable medium of claim 9, wherein the program further instructs the processing element to:
transmit, to the computing device, another prompt to be presented in the display of the computing device that provides the customer with a list of recommended appraisers and requests that the customer select one of the appraisers and grant permission to contact the selected one of the appraisers after a second time period; and
in response to receiving, from the computing device, information indicating that the customer provided the permission regarding the selected one of the appraisers, transmit, to a device associated with the selected one of the appraisers, a request for a copy of the appraisal.

11. The non-transitory computer-readable medium of claim 8, wherein the program further instructs the processing element to:
transmit, to the computing device, another prompt to be presented in the display of the computing device that asks the customer what type of material is used for the roof of the customer's house;
in response to receiving, from the computing device, information indicating that the customer answered that the roof material is impact-resistant, transmit, to the computing device, another prompt to be presented in the display of the computing device that asks the customer for contact information regarding a contractor and permission to contact the contractor; and
in response to receiving, from the computing device, information indicating that the customer provided the contact information and permission regarding the contractor, transmit, to a device associated with the contractor, a request for proof of the completed work on the roof.

12. The non-transitory computer-readable medium of claim 8, wherein the program further instructs the processing element to:
in response to receiving, from the computing device, information indicating that the customer answered “no” to purchasing safety or security products, transmit, to the computing device, another prompt to be presented in the display of the computing device that presents the customer with a list of approved vendors or manufacturers of safety and security products.

13. A computer server for retrieving data regarding insurance policy information from third-party sources, the computer server comprising:
a communication element configured to receive and transmit communications to and from a plurality of computing devices;
a memory element electronically coupled to the communication element, the memory element configured to store executable instructions; and
a processing element electronically coupled to the communication element and the memory element, the processing element configured to:
transmit, to a computing device, a prompt to be presented on a display of the computing device that asks a customer if the customer has purchased safety or security products for the customer's house,
in response to receiving, from the computing device, information indicating that the customer answered “yes” to purchasing safety or security products, transmit, to the computing device, another prompt to be presented in the display of the computing device that asks the customer for contact information regarding a vendor or contractor and permission to contact the vendor or contractor,
in response to receiving, from the computing device, information indicating that the customer provided the contact information and permission regarding the vendor or contractor,
transmit, to a device associated with the vendor or contractor, a request for proof of purchase or installation of the safety or security products,
receive, from the device associated with the vendor or contractor, documentation data of the safety or security products;
determine one or more features of the safety or security products based upon computer analysis of the documentation data;
collect home sensor data from at least one of a sensor and a smart home controller;
analyze the home sensor data using at least one of an object recognition program and a pattern recognition program to identify at least one of the safety or security products;
verify an installation of the at least one of the safety or security products based on the analysis of the home sensor data; and
in response to receiving, from the computing device, information indicating that the customer answered “no” to purchasing safety or security products, transmit, to the computing device, another prompt to be presented in the display of the computing device that presents the customer with information regarding safety or security products with features that may generate an insurance premium discount.

14. The computer server of claim 13, wherein the processing element is further configured to:
transmit, to the computing device, another prompt to be presented in the display of the computing device that asks the customer if the customers owns valuable possessions,
in response to receiving, from the computing device, information indicating that the customer answered “yes” to owning valuable possessions, transmit, to the computing device, another prompt to be presented in the display of the computing device that asks the customer if the customer has had the valuable possessions appraised within a predetermined first time period,
in response to receiving, from the computing device, information indicating that the customer has had the valuable possessions appraised, transmit, to the computing device, another prompt to be presented in the display of the computing device that asks the customer for contact information regarding an appraiser and permission to contact the appraiser, and
in response to receiving, from the computing device, information indicating that the customer provided the contact information and permission regarding the appraiser, transmit, to a device associated with the appraiser, a request for a copy of the appraisal.

15. The computer server of claim 13, wherein the processing element is further configured to:
in response to receiving, from the computing device, information indicating that the customer has not had the valuable possessions appraised, transmit, to the computing device, another prompt to be presented in the display of the computing device that requests that the customer get the valuable possessions appraised by an appraiser and asks for contact information regarding the appraiser and permission to contact the appraiser, and
in response to receiving, from the computing device, information indicating that the customer provided the contact information and permission regarding the appraiser, transmit, to a device associated with the appraiser, a request for a copy of the appraisal.

16. The computer server of claim 13, wherein the processing element is further configured to:
transmit, to the computing device, another prompt to be presented in the display of the computing device that provides the customer with a list of recommended appraisers and requests that the customer select one of the appraisers and grant permission to contact the selected one of the appraisers after a second time period, and
in response to receiving, from the computing device, information indicating that the customer provided the permission regarding the selected one of the appraisers, transmit, to a device associated with the appraiser, a request for a copy of the appraisal.

17. The computer server of claim 13, wherein the processing element is further configured to:
transmit, to the computing device, another prompt to be presented in the display of the computing device that asks the customer what type of material is used for the roof of the customer's house,
in response to receiving, from the computing device, information indicating that the customer answered that the roof material is impact-resistant, transmit, to the computing device, another prompt to be presented in the display of the computing device that asks the customer for contact information regarding a contractor and permission to contact the contractor, and
in response to receiving, from the computing device, information indicating that the customer provided the contact information and permission regarding the contractor, transmit, to a device associated with the contractor, a request for proof of the completed work on the roof.

18. The computer server of claim 13, wherein the processing element is further configured to:
in response to receiving, from the computing device, information indicating that the customer answered “no” to purchasing safety or security products, transmit, to the computing device, another prompt to be presented in the display of the computing device that presents the customer with a list of approved vendors or manufacturers of safety and security products.

19. The computer-implemented method of claim 1, further comprising:
transmitting, by the server to the computing device, another prompt to be presented on the display of the computing device that asks the customer if the customer has had renovation work performed on the customer's house;
in response to receiving, by the server from the computing device, information indicating that the customer answered “yes” to having had renovation work performed, transmitting, by the server to the computing device, another prompt to be presented on the display of the computing device that asks the customer for contact information regarding a contractor and permission to contact the contractor;
in response to receiving, by the server from the computing device, information indicating that the customer provided the contact information and permission regarding the contractor, transmitting, by the server to a device associated with the contractor, a request for proof of the completed renovation work; and
in response to receiving, by the server from the computing device, information indicating that the customer answered “no” to having had renovation work performed, transmitting, by the server to the computing device, another prompt to be presented on the display of the computing device that presents the customer with information that certain types of renovation work may generate an insurance premium discount.

20. The non-transitory computer-readable medium of claim 8, wherein the program further instructs the processing element to:
transmitting, to the computing device, another prompt to be presented in the display of the computing device that asks the customer if the customer has had renovation work performed on the customer's house;
in response to receiving, from the computing device, information indicating that the customer answered “yes” to having had renovation work performed, transmitting, to the computing device, another prompt to be presented in the display of the computing device that asks the customer for contact information regarding a contractor and permission to contact the contractor;
in response to receiving, from the computing device, information indicating that the customer provided the contact information and permission regarding the contractor, transmitting, to a device associated with the contractor, a request for proof of the completed renovation work; and
in response to receiving, from the computing device, information indicating that the customer answered “no” to having had renovation work performed, transmitting, to the computing device, another prompt to be presented in the display of the computing device that presents the customer with information that certain types of renovation work may generate an insurance premium discount.

21. The computer server of claim 13, wherein the processing element is further configured to:
transmit, to the computing device, another prompt to be presented in the display of the computing device, that asks the customer if the customer has had renovation work performed on the customer's house,
in response to receiving, from the computing device, information indicating that the customer answered “yes” to having had renovation work performed, transmit, to the computing device, another prompt to be presented in the display of the computing device that asks the customer for contact information regarding a contractor and permission to contact the contractor,
in response to receiving, from the computing device, information indicating that the customer provided the contact information and permission regarding the contractor, transmit, to a device associated with the contractor, a request for proof of the completed renovation work, and
in response to receiving, from the computing device, information indicating that the customer answered “no” to having had the renovation work performed, transmit, to the computing device, another prompt to be presented in the display of the computing device that presents the customer with information that certain types of renovation work may generate an insurance premium discount.
